(19) United States
(12) Patent Application Publication
(10) Pub. No.: US 2009/0172026 A1
(43) Pub. Date: Jul. 2, 2009

(54) PERSONALIZED INFORMATION FILTER BASED ON SOCIAL TAGS

(75) Inventors: Elizabeth A. Brownholtz, Andover, MA (US); Casey Dugan, Medford, MA (US); Werner Geyer, Boston, MA (US); Charles R. Hill, Belmont, MA (US); David R. Millen, Boxwood, MA (US); Michael Muller, Medford, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/967,654

(22) Filed: Dec. 31, 2007

(51) Int. Cl. G06F 17/30

(52) U.S. Cl. 707/104.1; 707/E17.044

(57) ABSTRACT

Embodiments of the present invention address deficiencies of the art in respect to content personalization and provide a method, system and computer program product for tag-based content personalization. In an embodiment of the invention, a method for tag based personalization of content can be provided. The method can include comparing tags for a user in a social bookmarking system to keywords for content received for the user. The method further can include filtering the content when the keywords do not compare favorably with the tags. In this way, the content preference of a user can be inferred irrespective of the environment in which the content is provided as the keywords of the content can be compared with tags associated with the interests of the recipient of the content.

### BACKGROUND OF THE INVENTION

1. Field of the Invention

The present invention relates to the field of content management and more particularly to personalizing desired content for delivery over a computer communications network.

2. Description of the Related Art

Amongst the innumerable benefits of the global computer communications network known as the Internet, wide scale content distribution remains a prime motivator for the interactions of most end users with the Internet. Even prior to the advent of the World Wide Web, academics and hobbyists alike relied on precursor technologies like Archie, Gopher and Veronica for the dissemination of electronic content on a wide-scale basis. The Web; however, unleashed the furies such that today nary a first grader has not experienced the power of the Web for content distribution in scanning the Web for hundreds if not thousands of pages of electronic content.

Content can be accessed over the Internet in two respects. In a first respect, content is pulled by the end user at the express direction of the end user. In contrast, in a second respect content is pushed to the end user, oftentimes without the express direction of the end user. In the latter circumstance, content can be pushed to the end user through a number of communicative mechanisms, including messaging, news feeds and portlets in a portal environment.

In many cases, an end user can participate in the type of content pushed to the end user by pre-selecting the content or at least the nature of the content. In this regard, many content sources allow the end user first to opt in to receiving content from the content source and secondly to specify which types of content are preferred by the end user. Yet, preferences can change over time. Where the end user provides preferences for content to only a few content sources, modifying the preferences can be of little impact to the end user. By comparison, where the end user provides preferences for content to a large number of content sources, it can be burdensome to manage those preferences over an extended period of time.

Addressing the obtrusive nature of manually specifying preferences, sophisticated online retailers observe patterns of behavior on the part of the end user to infer the preferences. For instance, a particular shopping pattern or pattern of reading particular types of content can result in preferences for content distribution that reflect the observed patterns such as the presentation of specific advertisements or the suggestion of products for purchase. Popular examples include suggested music for download in an online music store, or suggested books for purchase in an online bookstore. Still, inferring preferences from patterns ordinarily involves navigation and interaction patterns in a retail environment, however, content intended for distribution oftentimes bears little relation to retail navigation and interaction patterns. Thus, inferring a content preference based upon prior purchasing patterns can be limited in application to the online retail environment.

### BRIEF SUMMARY OF THE INVENTION

Embodiments of the present invention address deficiencies of the art in respect to content personalization and provide a novel and non-obvious method, system and computer program product for tag-based content personalization. In an embodiment of the invention, a method for tag based personalization of content can be provided. The method can include comparing tags for a user in a social bookmarking system to keywords for content received for the user. The method further can include filtering the content when the keywords do not compare favorably with the tags. In this way, the content preference of a user can be inferred irrespective of the environment in which the content is provided as the keywords of the content can be compared with tags associated with the interests of the recipient of the content.

In one aspect of the embodiment, comparing tags for a user in a social bookmarking system to keywords for content received for the user can include comparing tags in the social bookmarking system for a user and for other users of the social bookmarking system, to keywords for content received for the user. In another aspect of the embodiment, filtering the content when the keywords do not compare favorably with the tags can include filtering the content when the keywords do not match the tags. In yet another aspect of the embodiment, the method further can include limiting the tags during comparison to those tags either contributed or accessed during a minimum window of time or a variable window of time. Finally, the method can include limiting the tags during comparison to those tags belonging to a specified topic.

In another embodiment of the invention, a tag based personalization of content data processing system can be provided. The system can include a host computing platform, a data store of tags collected from different tag aggregators in connection with an end user and a classifier coupled to the data store and the host computing platform. Optionally, the data store of tags can include records, each specifying at least a tag, a user identifier for a user associated with the tag and a date of contribution for the tag. The classifier in turn, can include tag based personalization program code enabled to compare tags in the data store to keywords for received content for a user to determine whether or not the content is likely to be of interest to the user.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for tag-based content personalization;

FIG. 2 is a schematic illustration of a tag-based content personalization data processing system; and,

FIG. 3 is a flow chart illustrating a process for tag-based content personalization.

### DETAILED DESCRIPTION OF THE INVENTION

Embodiments of the present invention provide a method, system and computer program product for tag-based content personalization. In accordance with an embodiment of the present invention, tags applied to content viewed in association with a subject user can be collected and stored in association with the subject user. Subsequently, new content can be received by the subject user and compared to the collected tags. If the new content compares favorably to the collected tags, the new content can be viewed by the subject user. Otherwise, the new content can be filtered from view by the subject user. In this way, the new content can be personalized based upon the tags collected in association with the subject user.

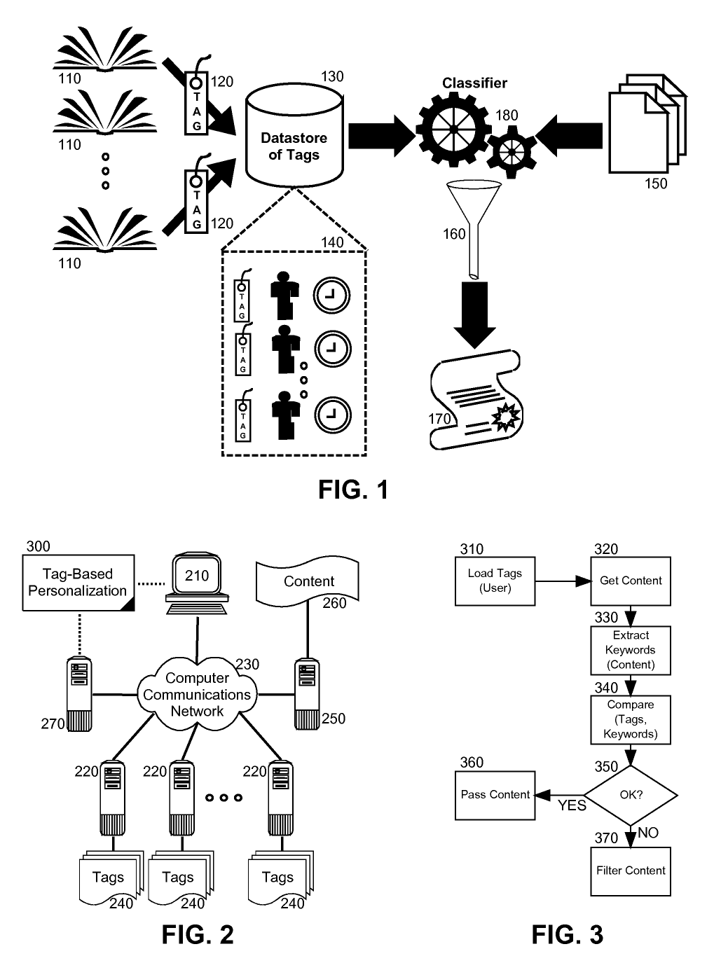

In illustration, FIG. 1 pictorially depicts a process for tag-based content personalization. As shown in FIG. 1, tags 120 can be applied to content from multiple different content sources and collected within different social bookmarking systems 110. Each of the tags 120 can be stored in a data store of tags 130 in a record 140 in connection with a user and also a date and time stamp. Thereafter, a classifier 180 can access each of the records 140 in the data store of tags 130. The classifier 180 can process the tags 120 to produce keywords for comparison to keywords extracted from newly received content 150. Based upon the comparison for a given user receiving new content 170, a filter 160 can pass through new content 170 consistent with the tags 120 for the given user.

The process described herein can be embodied within a data processing system including supporting computing platforms, each typically incorporating a power supply, one or more central processing units (CPUs), memory, fixed storage, a display and one or more input devices. In further illustration, FIG. 2 schematically depicts a tag-based content personalization data processing system. The system can include a host computing platform 210 configured for coupling to multiple different servers 220 over a computer communications network. Each of the servers 220 can provide tag aggregation of tags 240 associated with different users for content viewed over the computer communications network 230.

In this regard, each of the servers 220 can host alone or in combination with others of the servers 220 a social bookmarking service such that tags 240 can be associated with an end user not only because of the tagging actions of the end user, but also due to the tagging actions of other users in appreciation of the likelihood that all users in the system can share a similar view of content and a similar preference to view particular content. Notably, the host computing platform 210 can be coupled to tag based personalization logic 300 which in turn can access the tags 240 either directly from the servers 220, or indirectly through the host computing platform 210. Optionally, the tag based personalization logic 300 can reside in the host computing platform 210. Alternatively, the tag based personalization logic 300 can reside in a separate server 270 communicatively coupled to the host computing platform 210 over the computer communications network 230.

The tag based personalization logic 300 can include program code enabled to compare keywords derived from ones of the tags 240 with keywords extracted from or derived from content 260 provided by content server 250 to the host computing platform 210. The tags 240 can include all tags associated with a user of the host computing platform 210 or the tags 240 contributed by other users within the system. Alternatively, the tags 240 can include only those tags contributed or used (or both) during a specified time frame. The time frame can be fixed in terms of a duration or a range of dates, or dynamic in terms of a time window. Further, the time frame can be extended in response to determining that a threshold number of the tags 240 do not fall within the time frame so as to provide a meaningful set of the tags 240 for the comparison.

Even yet further, the tags 240 can be organized by topic and the end user can select a topic or topics in response to which only those of the tags 240 associated with the selected topic or topics are to be included during the comparison. In any case, based upon the comparison, it can be determined whether or not the content 260 is likely to be of interest to the end user. If so, the content 260 can be passed along to the end user. Otherwise, the content 260 can be filtered. In either case, it is to be recognized that the content 260 can include not only Web content, but also postings, events, tasks, activities or other entries in a collaborative computing environment, or messages in a messaging environment including e-mail and instant messages.

In further illustration of the operation of the tag based personalization logic 300, FIG. 3 is a flow chart illustrating a process for tag-based content personalization. The process can begin in block 310 with the loading of a tag set for a particular user. In block 320, content can be received for viewing by the particular user. In block 330, keywords can be determined for the received content. For instance, tags applied to the content can be used as keywords, or keywords can be extracted from the content directly. In block 340, the keywords for the content can be compared to the tags in the loaded tag set. In decision block 350, if the keywords compare favorably, in block 360 the content can be passed through for viewing by the particular user. Otherwise, in block 370 the content can be filtered.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for tag based personalization of content, the method comprising:
comparing tags for a user in a social bookmarking system to keywords for content received for the user; and,
filtering the content when the keywords do not compare favorably with the tags.

2. The method of claim 1, wherein comparing tags for a user in a social bookmarking system to keywords for content received for the user, comprises comparing tags in the social bookmarking system for a user and for other users of the social bookmarking system, to keywords for content received for the user.

3. The method of claim 1, wherein filtering the content when the keywords do not compare favorably with the tags, comprises filtering the content when the keywords do not match the tags.

4. The method of claim 1, further comprising limiting the tags during comparison to those tags either contributed or accessed during a minimum window of time.

5. The method of claim 1, further comprising limiting the tags during comparison to those tags either contributed or accessed during a variable window of time.

6. The method of claim 5, further comprising expanding the variable window of time when a number of tags either contributed or accessed during a specified time frame falls below a threshold value.

7. The method of claim 1, further comprising limiting the tags during comparison to those tags belonging to a specified topic.

8. A tag based personalization of content data processing system comprising:
a host computing platform;
a data store of tags collected from different tag aggregators in connection with an end user; and,
a classifier coupled to the data store and the host computing platform, the classifier comprising tag based personalization program code enabled to compare tags in the data store to keywords for received content for a user to determine whether or not the content is likely to be of interest to the user.

9. The system of claim 8, wherein the data store of tags comprises a plurality of records each record specifying at least a tag, a user identifier associating an end user with the tag and a date of contribution for the tag.

10. The system of claim 8, wherein the keywords comprises tags for the received content.

11. The system of claim 8, wherein the tags use in comparing are tags either contributed or accessed within a specified time frame.

12. The system of claim 11, wherein the time frame is a minimum time window.

13. The system of claim 11, wherein the time frame is a variable time window that can be expanded or contracted.

14. A computer program product comprising a computer usable medium embodying computer usable program code for tag based personalization of content, the computer program product comprising:
computer usable program code for comparing tags for a user in a social bookmarking system to keywords for content received for the user; and,
computer usable program code for filtering the content when the keywords do not compare favorably with the tags.

15. The computer program product of claim 14, wherein the computer usable program code for comparing tags for a user in a social bookmarking system to keywords for content received for the user, comprises computer usable program code for comparing tags in the social bookmarking system for a user and for other users of the social bookmarking system, to keywords for content received for the user.

16. The computer program product of claim 14, wherein the computer usable program code for filtering the content when the keywords do not compare favorably with the tags, comprises computer usable program code for filtering the content when the keywords do not match the tags.

17. The computer program product of claim 14, further comprising computer usable program code for limiting the tags during comparison to those tags either contributed or accessed during a minimum window of time.

18. The computer program product of claim 14, further comprising computer usable program code for limiting the tags during comparison to those tags either contributed or accessed during a variable window of time.

19. The computer program product of claim 18, further comprising computer usable program code for expanding the variable window of time when a number of tags either contributed or accessed during a specified time frame falls below a threshold value.

20. The computer program product of claim 14, further comprising computer usable program code for limiting the tags during comparison to those tags belonging to a specified topic.
